(19) United States
(12) Patent Application Publication
(10) Pub. No.: US 2007/0007351 A1
(43) Pub. Date: Jan. 11, 2007

(54) [LIGHT SOURCE AND LENS ARRANGEMENT FOR BARCODE SCANNER]

(75) Inventor: Ting-Hao Hsiao, TAIPEI (TW)

Correspondence Address: MARSON TECHNOLOGY CO., LTD., P.O. BOX 108-00403, TAIPEI, TW

(73) Assignee: MARSON TECHNOLOGY CO., LTD., Hsin-Tien City (TW)

(21) Appl. No.: 11/160,763

(22) Filed: Jul. 7, 2005

(51) Int. Cl. G06K 7/10

(52) U.S. Cl. 235/462.35

(57) ABSTRACT

A light source and lens arrangement used in a barcode scanner is disclosed to include a lens, and two light sources arranged at two opposite lateral sides of the lens for emitting light onto a barcode for enabling the lens to pick up the image of the barcode and to map the image onto an image plane, each light source including a light-emitting diode, and a mirror having a reflecting surface of anisocurvature design for reflecting light from the light-emitting element toward the barcode for enabling the lens to a bright image of the barcode in uniform brightness.

### BACKGROUND OF THE INVENTION

1. Field of the Invention

The present invention relates to a barcode scanner and more particularly, to a light source and lens arrangement for barcode scanner, which enables the lens to pick up the image of the barcode in uniform brightness.

2. Description of the Related Art

In the multimedia era, needs for optical input devices are expected to increase in terms of both quality and quantity. For automation in commercial as well as in industry, barcode has been intensively used to mark and classify products, tools, and equipments. A barcode scanner is an electronic device for scanning a barcode and generating a digital representation of the scanned barcode for reading.

FIGS. 2 and 3 show a light emitting element and a lens with a shade for use in a barcode scanner according to the prior art. The barcode scanner uses the light-emitting element A to illuminate the barcode (not shown). According to this design, light rays are gathered in the center area of the barcode. Therefore, the intensity of light projected onto the center area of the barcode is comparatively higher than the intensity of light projected onto the lateral sides of the barcode. When the lens B picked up the image of the barcode, the brightness of the mapped image is not uniform, and the signal thus obtained may be weak, resulting in a reading error. Further, when picking up the image of a barcode, a comparatively greater amount of light from the center area of the barcode passes through the relatively broader middle area of the lens, and a comparatively smaller amount of light passes from the two opposite lateral sides of the barcode through the two relatively narrower lateral areas of the lens, thereby worsening the problem of non-uniform brightness of the image. In order to eliminate the problem of non-uniform brightness, a light shade B1 may be attached to the lens B. However, the use of the light shade B1 weakens the brightness of the image, and the weakening of the brightness of the image becomes more significant if the light-emitting element A produces an attenuation of light due to a long use.

Therefore, it is desirable to provide a light source and lens arrangement for barcode scanner that produces a bright image of uniform brightness of the scanned object.

### SUMMARY OF THE INVENTION

The present invention has been accomplished under the circumstances in view. It is one object of the present invention to provide a light source and lens arrangement for barcode scanner, which enables light rays to enter the lens uniformly so that the lens can map the image of the barcode in uniform brightness onto an image plane for processing into a strong and clear signal for accurate reading. To achieve and other objects of the present invention, the light source and lens arrangement is used in a barcode scanner, comprising a lens, and two light sources arranged at two opposite lateral sides of the lens and adapted to emit light onto a barcode for enabling the lens to pick up the image of the barcode and to map the image onto an image plane. The light sources each comprise a light-emitting element, and a mirror disposed at one side relative to the light-emitting element. The mirror has a reflecting surface adapted to reflect light from the light-emitting element toward a predetermined direction. The reflecting surface has an anisocurvature for reflecting light onto the barcode in such a manner that the intensity of light projected onto the center area of the barcode is comparatively weaker than the intensity of light projected onto the two opposite lateral sides of the barcode, so that the image of the barcode mapped onto the image plane has a uniform brightness, and the barcode scanner can obtain a strong and clear signal for accurate reading of the content of the barcode during the posterior processing process.

### BRIEF DESCRIPTION OF THE DRAWINGS

FIG. 1 is schematic drawing showing the operation of a light source and lens arrangement according to the present invention.

FIG. 2 is a schematic drawing showing the functioning of the light-emitting element for barcode scanner according to the prior art.

FIG. 3 is a schematic drawing showing a lens with a shade for use in a barcode scanner according to the prior art.

### DETAILED DESCRIPTION OF THE PREFERRED EMBODIMENT

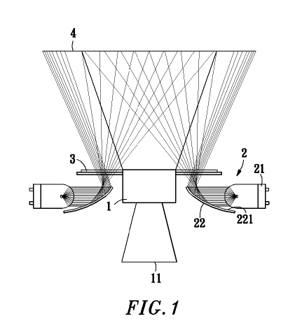

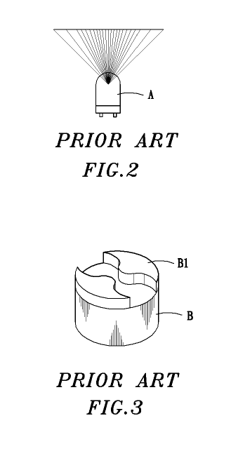

Referring to FIG. 1, a barcode scanner is shown comprising a lens 1, a plurality of light sources 2, and a plurality of condenser elements 3.

The lens 1 is adapted to pick up the image of the object in front of the barcode scanner and to map the image onto an image plane 11.

The light sources 2 are provided at two sides relative to the lens 1, each comprising a light-emitting element 21 and a mirror 22. The mirror 22 is disposed near one side of the respective light-emitting element 21, having a reflecting surface 221 of anisocurvature design facing the light-emitting element 21.

The condenser elements 3 are disposed at two sides relative to the lens 1 and spaced from the light-emitting elements 21 of the light sources 2 at one side opposite to the mirrors 22 of the light sources 2.

When using the barcode scanner, the light-emitting elements 21 of the light sources 2 are driven to emit light onto the reflecting surface 221 of the mirror 22 of each of the light sources 2, and the reflecting surface 221 of the mirror 22 of each of the light sources 2 reflects light from the light-emitting elements 21 onto a barcode 4 through the condenser elements 3. Because the reflecting surface 221 of the mirror 22 of each of the light sources 2 is a curved surface having an anisocurvature design, the intensity of light projected onto the center area of the barcode 4 is comparatively weaker than the intensity of light projected onto the two opposite lateral sides of the barcode 4. When the lens 11 picking up the image of the barcode 4, a comparatively greater amount of light from the center area of the barcode 4 passes through the relatively broader middle area of the lens 11, and a comparatively smaller amount of light passes from the two opposite lateral sides of the barcode 4 through the two relatively narrower lateral areas of the lens 11. Therefore, when the image of the barcode 4 is mapped onto the image plane 11, the mapped image has a uniform brightness, and the barcode scanner can obtain a strong and clear signal for accurate reading of the content of the barcode during the posterior processing process.

Further, the condenser elements 3 condense reflected light from the reflecting surface 221 of the mirror 22 of each of the light sources 2 into linear light rays to fit the elevation of the barcode 4, enabling light rays to be effectively gathered in the barcode 4 so that the lens 1 can pick up a bright image of the barcode 4.

Further, the light-emitting element 21 of each light source 2 can be a LED (light emitting diode) or laser LED.

As indicated above, the invention has the following features.

1. The mirror of each light source has a reflecting surface of anisocurvature design for reflecting light onto the barcode in such a manner that the intensity of light projected onto the center area of the barcode is comparatively weaker than the intensity of light projected onto the two opposite lateral sides of the barcode, so that the image of the barcode mapped onto the image plane has a uniform brightness, and the barcode scanner can obtain a strong and clear signal for accurate reading of the content of the barcode during the posterior processing process.

2. The invention uses the anisocurvature design of the reflecting surface of the mirror of each of the light sources to distribute the light rays from the light-emitting elements of the light sources, enabling light to enter the lens when the lens is picking up the image of the barcode, and therefore the barcode scanner can obtain the image of the barcode in uniform brightness for processing into a strong and clear signal for accurate reading.

A prototype of light source and lens arrangement for barcode scanner has been constructed with the features of FIG. 1. The light source and lens arrangement for barcode scanner functions smoothly to provide all of the features discussed earlier.

Although a particular embodiment of the invention has been described in detail for purposes of illustration, various modifications and enhancements may be made without departing from the spirit and scope of the invention.

What is claimed is:

1. A light source and lens arrangement used in a barcode scanner, comprising a lens, and two light sources arranged at two opposite lateral sides of said lens and adapted to emit light onto a barcode for enabling said lens to pick up the image of the barcode and to map the image onto an image plane, wherein said light sources each comprise a light-emitting element, and a mirror disposed at one side relative to said light-emitting element, said mirror having a reflecting surface adapted to reflect light from said light-emitting element toward a predetermined direction, said reflecting surface having an anisocurvature.

2. The light source and lens arrangement as claimed in claim 1, wherein said light-emitting element is a light-emitting diode.

3. The light source and lens arrangement as claimed in claim 1, wherein said light emitting element is a laser light-emitting diode.

4. The light source and lens arrangement as claimed in claim 1, wherein said light sources each further comprise a condenser element disposed at one side of the respective light-emitting element opposite to the respective mirror for condensing light reflected by the respective mirror.
